(19) United States
(12) Patent Application Publication
(10) Pub. No.: US 2015/0128881 A1
(43) Pub. Date: May 14, 2015

(54) METHOD FOR MANUFACTURING BOILER WATER WALLS AND BOILER WITH LASER/ARC WELDED WATER WALLS

(71) Applicant: Chicago Tube and Iron Company, Romeoville, IL (US)

(72) Inventors: Peter T. Nance, Charlotte, NC (US); Brett Jamison Bercaw, Locust, NC (US)

(21) Appl. No.: 14/534,554

(22) Filed: Nov. 6, 2014

Related U.S. Application Data
(60) Provisional application No. 61/904,173, filed on Nov. 14, 2013.

(51) Int. Cl. F22B 21/40; B23K 26/14; B23K 26/26; B21D 53/06

(52) U.S. Cl. CPC F22B 21/40; B21D 53/06; B23K 26/1429; B23K 26/26
USPC 122/235.14; 219/121.64; 29/890.046; 29/890.051; 29/890.054; 122/235.23

(57) ABSTRACT

A method of fabricating boiler water walls that includes the steps of forming a subpanel formed of at least one fin and one tube by laser arc welding the at least one fin to the one tube and then laser arc welding a predetermined plurality of subpanels together in a two-dimensional plane by laser arc welding an additional joining element between respective subpanels to form the water wall.

### CROSS REFERENCE TO RELATED PATENT APPLICATION

This application claims priority to U.S. Provisional Patent Application No. 61/904,173, filed Nov. 14, 2013, the contents of which are incorporated into this application in its entirety.

### TECHNICAL FIELD AND BACKGROUND OF THE INVENTION

The present invention relates to a method for manufacturing water walls utilizing hybrid laser arc welding (“HLAW”) and boilers having water walls fabricated by this method. A “water wall” is a wall within a boiler enclosure that is constructed of numerous, closely spaced water tubes. The tubes are evenly spaced from each other by intermediately-positioned fins, and generally connect to headers which in turn are connected back to the main generating bank of the boiler. They serve a two-fold purpose in that they capture heat that would otherwise escape to the atmosphere and help heat the water in the boiler. The tubes also help keep the refractory cool, relatively speaking, which prevents spalling of the refractory. Water flows up the tubes in the water walls of the boiler and surrounds a fireball of burning fuel. The water in the tubes is heated by radiation from the fireball. Some of the water in these tubes turns into steam. The steam and water in the water wall tubes is sent to the steam drum, where steam is separated from liquid water.

Welded boiler water wall panels are a common design feature for most utility and large industrial boilers. Welded furnace walls, in addition to containing the water/steam mixture within the tubing, provide both a gas-tight seal and structural support to the furnace. Most large utility boilers are top supported and designed to thermally grow downward as the boiler starts operation. In most top supported designs, the water wall panels are load bearing, transferring the deadweight of the furnace, burners, and ductwork back to the structural steel. In addition to the deadweight loading, the water walls are subject to thermal stresses resulting from operating transients, such as start-up and shutdown, when the individual tube temperatures (fire side and fluid side) across the furnace wall panels may be unequal.

These unbalanced thermal conditions create complex stress patterns in the water wall panels. Furthermore, NFPA 85 requires that the furnace be capable of withstanding transient loads due to a malfunction or improper operation of fans or dampers, as well as the stresses created by a master fuel trip while operating at the maximum design load. The boiler designer takes these forces and moments into consideration when calculating the dimensions of the tubing, fin, and fin weld. Implicit in those calculations is an assumption that the tube to fin weld is sound and stress transference is possible from tube to tube. As such, the tube to fin weld is integral to the structural integrity of a boiler.

Traditionally, boiler water wall panels are fabricated in a shop using automated welding processes such as the submerged arc welding (“SAW”) or flux core arc welding (“FCAW”) process to join the fins to the tubing. The SAW process can create welds with good fusion at a high deposition rate, but the resulting water walls are often distorted because of residual stresses from weld shrinkage that occurs as the weld solidifies. Because dimensional tolerances are crucial for proper installation, often much time and effort is taken at the fabrication facility to straighten distorted panels in order to meet contractual requirements. This rework does not reduce the overall level of residual stress in the panel, unless a post-weld heat treatment is performed after straightening operations are complete. Residual stress within the panels can be of concern, especially if the panels are subsequently coated with a protective overlay or are installed in boilers experiencing service-related cracking, such as oxidation-sulfidation attack or fatigue.

The process according to this invention relates to a hybrid welding process combining Gas Metal Arc Welding (“GMAW”) and laser welding designed to work together so that lengths of boiler tube can be welded to a fin to create subpanels that are then welded together to create a flat wall for a boiler. This combination of laser and GMAW allows the energy of the laser to be concentrated within a narrow range to deepen the penetration of the base metal weld, permits higher welding speeds while nevertheless avoiding or substantially reducing distortion from heat generated by the welding process.

Traditional laser welding and GMAW are examples of different types of welding processes for joining solid metals. With laser welding, a laser beam is focused on single point of contact between two base metals by means of a fiber optic system that includes lenses and a high energy focused coherent light. This system does not supply any additional wire or filler metal and typically joins the two parts by fusing the two materials together. The fit up of the parts is extremely important.

GMAW functions by means of an electric arc generated between a base metal and a consumed metal wire electrode that is fed automatically from a bobbin, and surrounded is by a covering gas that shields the weld zone and surrounding area. A dedicated arc welding head is used for the GMAW process. While good for filling gaps, this process has very limited utility for welding operations that requires deeper penetration into the base metals being welded. In addition to the lack of penetration, the welding arc becomes unstable at speeds higher than six feet per minute and generates tremendous heat, causing distortion of the base material.

HLAW, which combines laser welding and the GMAW process, has been previously employed in an attempt to overcome the drawbacks of the two conventional welding methods. HLAW aligns the electrode wire used in the GMAW process and the laser beam so that their combined energy can create a deep penetrating weld capable of joining two base materials at high speed. The combination of laser welding and GMAW welding allows for more tolerance in the fit up of the base materials, better weld reinforcement, higher travel speeds and less distortion.

Development of this process started with certain assumptions regarding the appropriate manner to test whether combination of laser welding and GMAW welding would be feasible for commercial production of water wall subpanels and water walls. Initially, the weld heads were “staggered” so that weld heads on opposite sides of a tube were offset in the direction of tube movement as the welding process took place. In addition, the initial configuration of the subpanels was a tube-fin-tube arrangement whereby a single fin was welded into the space between two tubes. The GMAW heads were crossed so that a right hand head welded the left side of the fin to a tube, and vice versa. In this arrangement, an 18 degree work angle was used for the staggered GMAW heads, and an 11 degree work angle was used for the staggered laser weld heads. These practices and parameters were found to be unsatisfactory. Through trials, it was ultimately determined that satisfactory results are obtained by carrying out the process as described below, according to the disclosed preferred embodiment of the invention. The term “laser arc welding” as used in this application refers to the simultaneous use of a laser and gas metal arc welding techniques (“GMAW”) in combination to form a weld in a moving work piece.

### SUMMARY OF THE INVENTION

Therefore, it is an object of the invention to provide a method of welding water tubes and fins together to form water wall subpanels and water walls.

It is another object to provide a method of welding water tubes and fins together with a laser beam and GMAW process such that their combined energy can create a deep penetrating weld capable of joining two base materials at high speed.

It is another object to provide a method of welding water tubes and fins together with a laser beam and GMAW process that allows for more tolerance in the fit up of the base materials.

It is another object to provide a method of welding water tubes and fins together with a laser beam and GMAW process that provides better weld reinforcement than in conventional prior arc welding processes.

It is another object to provide a method of welding water tubes and fins together with a laser beam and GMAW process that permits higher travel speeds of the water tubes and fins as the welding process takes place.

It is another object to provide a method of welding water tubes and fins together with a laser beam and GMAW process that provides less distortion to the welded water tubes and fins, thus reducing the amount of rework required in a downstream process prior to installation.

These and other objects and advantages of the invention are provided by a method of fabricating boiler water walls that includes the steps of forming a subpanel formed of at least one fin and one tube by laser arc welding at least one fin to the one tube, and laser arc welding a predetermined plurality of subpanels together in a two-dimensional plane by laser arc welding an additional joining element between respective subpanels to form the water wall.

In accordance with another embodiment of the method, the step of forming a subpanel formed of at least one fin and one tube includes the step of laser arc welding first and second fins to opposite sides of a single tube.

In accordance with another embodiment of the method, the step of laser arc welding a predetermined plurality of subpanels together in a two-dimensional plane includes the step of laser arc welding the fin of a first subpanel to a first side of a tube and laser arc welding the fin of a second subpanel to a second side of the tube opposite the first side.

In accordance with another embodiment of the method of fabricating boiler water walls, the method includes the steps of forming a subpanel formed of at least one fin and one tube by laser arc welding first and second fins to opposite sides of a single tube, and then forming a predetermined plurality of subpanels in a two-dimensional plane by laser arc welding the fin of a first subpanel to a first side of a tube and laser arc welding the fin of a second subpanel to a second side of the tube opposite the first side.

In accordance with another embodiment of the method of fabricating boiler water walls, the method includes the steps of forming a single tube subpanel by laser arc welding first and second fins to opposite sides of a single tube, forming a predetermined plurality of three-tube subpanels in a two-dimensional plane by laser arc welding the fin of a first three-tube subpanel to a first side of a tube and laser arc welding the fin of a second three-tube subpanel to a second side of the tube opposite the first side, and forming subpanels having a progressively-larger number of tubes by laser arc welding the fins of subpanels to a first side of a tube and laser arc welding the fins of a second subpanel to a second side of the tube opposite the first side until the subpanels collectively form a water wall having a predetermined number of laser arc welded fins and tubes.

In accordance with another embodiment of the method of fabricating boiler water walls, the step of laser arc welding includes the steps of providing a first laser head and a first arc weld head positioned on a first side of a subpanel comprising at least two fins and at least one tube, and providing a second laser head and a second arc weld head positioned on a second side of a subpanel in opposing lateral alignment with the first laser head and arc weld head. The first and second laser heads and weld heads are positioned to bisect an angle defining a point of contact between the fins and the tube. The laser heads are activated and thereafter the arc weld heads are activated. The fins are welded to the tube as the subpanel moves past the first and second laser heads and the first and second arc weld heads.

In accordance with another embodiment of the method of fabricating boiler water walls, the fins are positioned against opposing sides of the tube and tack welded in position before the laser welding and arc welding steps occur.

In accordance with another embodiment of the method of fabricating boiler water walls, the method includes the steps of determining the correct size of a plurality of fins and tubes that will form the water wall, and tack welding first and second fins to opposing sides of a tube to form a subpanel. The subpanel is placed on an infeed conveyor and moved on the infeed conveyor to a laser/arc weld area. First and second laser heads and first and second arc weld heads are moved into a welding location on opposite sides of the tube at the intersection of the fins and the tube. The first and second laser heads and then the first and second arc weld heads are activated, thereby welding the fins to the tube as the subpanel is fed through the weld area. The subpanel is inverted and moved back to the infeed conveyor where the welding steps are repeated. The welded subpanel is matched with a second subpanel formed according to the method and the welding steps are repeated to join the subpanels together. The process steps are repeated until a predetermined number of subpanels have been assembled and welded into a single panel.

In accordance with another embodiment of the method of fabricating boiler water walls, the tubes have an outside diameter of 2.5 inches (6.4 cm) and the fins are 0.25 inches (0.64 cm) thick and 0.5 inches (1.27 cm) wide.

In accordance with another embodiment of the method of fabricating boiler water walls, the work angle of the arc weld heads in relation to a point of intersection between the fin and tube is 35 degrees.

In accordance with another embodiment of the method of fabricating boiler water walls, the work angle of the laser weld heads in relation to a point of intersection between the fin and tube is 10 degrees.

In accordance with another embodiment of the method of fabricating boiler water walls, the work angle of the arc weld heads in relation to a point of intersection between the fin and tube is between three and four times the work angle of the laser weld heads in relation to the point of intersection between the fin and the tube.

In accordance with another embodiment of the method of fabricating boiler water walls, the feed rate of the subpanel through the laser/arc weld area is between 60 and 120 inches (153 and 306 cm) per minute.

In accordance with a boiler fabricated in accordance with a preferred embodiment of the invention, a boiler is provided that includes an at least partially-surrounding water wall that includes a plurality of parallel water tubes formed by interconnected alternating fins and tubes wherein the fins are joined to the tubes by laser arc welding.

In accordance with another embodiment of the boiler, the water wall is formed by laser arc welding a predetermined plurality of subpanels of interconnected fins and tubes together in a two-dimensional plane by laser arc welding, and laser arc welding an additional fin between respective subpanels to form the water wall.

In accordance with another embodiment of the boiler, the water wall is formed in accordance with a method that includes the steps of determining the correct size of a plurality of fins and tubes that will form the water wall, tack welding first and second fins to opposing sides of a tube to form a subpanel, placing the subpanel on an infeed conveyor, and moving the subpanel on the infeed conveyor to a laser/arc weld area. First and second laser heads and first and second arc weld heads are moved into a welding location on opposite sides of the tube at the intersection of the fins and the tube. The first and second laser heads, and thereafter the first and second arc weld heads are activated. The fins are laser/arc welded to the tube as the subpanel is fed through the weld area. The subpanel and inverted and the subpanel is moved to the infeed conveyor where the welding steps are repeated. A plurality of subpanels is matched together and laser/arc welded together until a predetermined number of subpanels have been assembled and welded into a single panel.

### BRIEF DESCRIPTION OF THE DRAWING FIGURES

The present invention is best understood when the following detailed description of the invention is read with reference to the accompanying drawings, in which:

FIG. 1 is a side elevation of a power plant that includes a boiler incorporating water walls surrounding the boiler;

FIG. 1A is a fragmentary enlarged view of the water wall section of the boiler of FIG. 1;

FIG. 2 is an elevation of a fin-tube-fin type of subpanel from which a water wall is constructed according to a preferred embodiment of the invention;

FIG. 3 is an elevation of a tube-fin-tube type of subpanel from which a water wall is constructed according to one embodiment of the invention;

FIG. 4 is a fragmentary perspective view showing successive joining of tube and fin subpanels to form a water wall;

FIG. 5 is a perspective view showing the principal elements HLAW welding process, with two opposing laser welding heads and two opposing GMAW heads.

FIG. 6 is schematic cross-section showing the work angle two opposed GMAW heads welding fins to a water wall tube;

FIG. 7 is schematic cross-section showing the work angle two opposed laser weld heads welding fins to a water wall tube; and

FIG. 8 is a sequence of schematic views showing a preferred method of fabricating fin-tube-fin subpanels that are then combined with additional tubes to form a boiler water wall;

### DETAILED DESCRIPTION OF THE PREFERRED EMBODIMENT

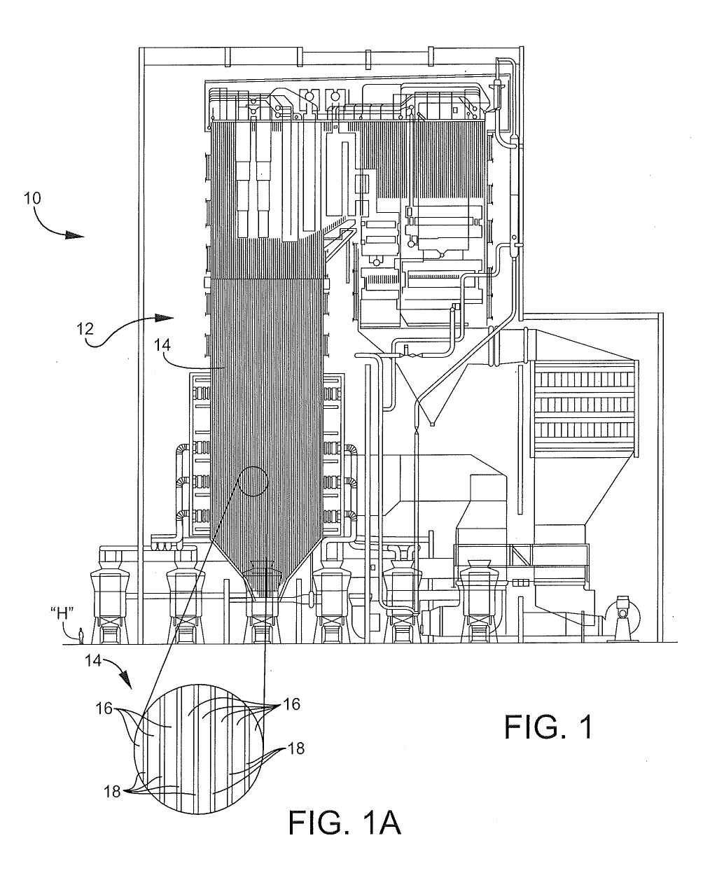

Referring now to FIG. 1, a side elevation of a Babcock and Wilcox Radiant Reheat Boiler 10 is shown. The boiler 10 is truly massive, as evidenced by the human “H”, shown to scale, standing in the lower left hand corner of the drawing. The boiler 10, which is exemplary of a wide range of types and sizes of boilers to which this invention has relevance, has a capacity of 3,305,000 lbs. (1,499,122 kg) of steam per hour at a superheater outlet pressure of 2,640 psi (12,890 kg/m2) and superheater outlet and reheat outlet temperature of 1,005 F (541C).

The boiler 10 includes a furnace 12 that is surrounded with water walls 14. The water walls 14 are formed of miles of tubes 16 joined together by fins 18 in the manner described in detail in this application.

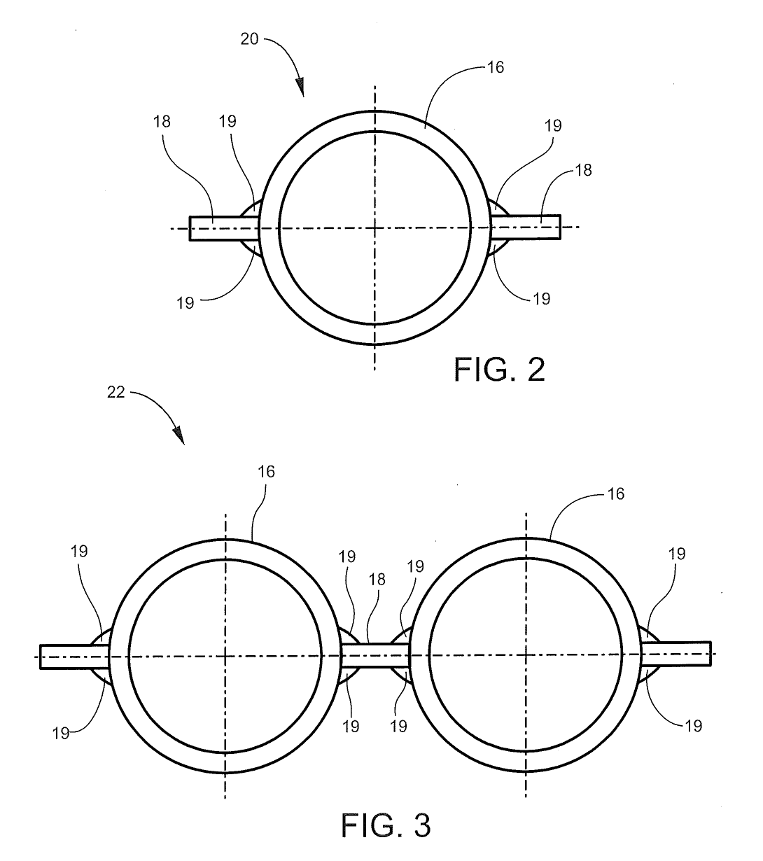

Referring now to FIG. 2, a preferred manner of forming subpanels begins with a single tube 16 to which are welded a pair of fins 18. The fins 18 extend radially-outwardly from diametrically opposite sidewalls of the tube 16 to form a subpanel 20. This is referred to as a “fin-tube-fin” subpanel. Each weld results in a weld bead 19 extending along the length of the joined tube 16 and fin 18. The weld beads 19 are formed at the perpendicular juncture of alternating tubes 16 and fins 18.

As shown in FIG. 3, a less desirable prior art manner of joining the fins and tubes is shown in which two tubes 16 are joined by a single fin 18 to diametrically-opposed sidewalls of the tubes 16 to form a subpanel. This is referred to as a “tube-fin-tube” subpanel.

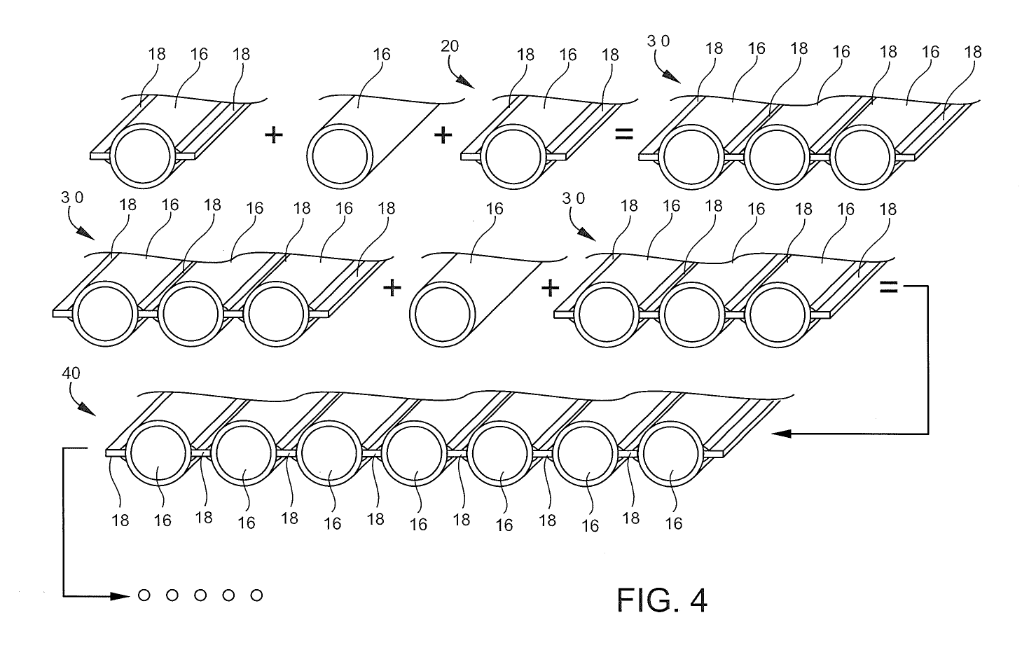

Referring now to FIG. 4, the preferred manner of forming the water wall 14 of FIG. 1 begins by forming subpanels 20 according to FIG. 2. Two of these subpanels 20 are joined by welding a tube 16 between the two subpanels 20 in the manner shown to create a larger subpanel 30. The weld beads are omitted from FIG. 4 for clarity, but are as shown in FIG. 2. Then, two of the subpanels 30 are joined by welding a tube 16 between the two subpanels 30 in the manner shown to create a yet larger subpanel 40. This process continues, as indicated by the ellipsis in FIG. 4, until panels are of a size suitable to form the water wall 14.

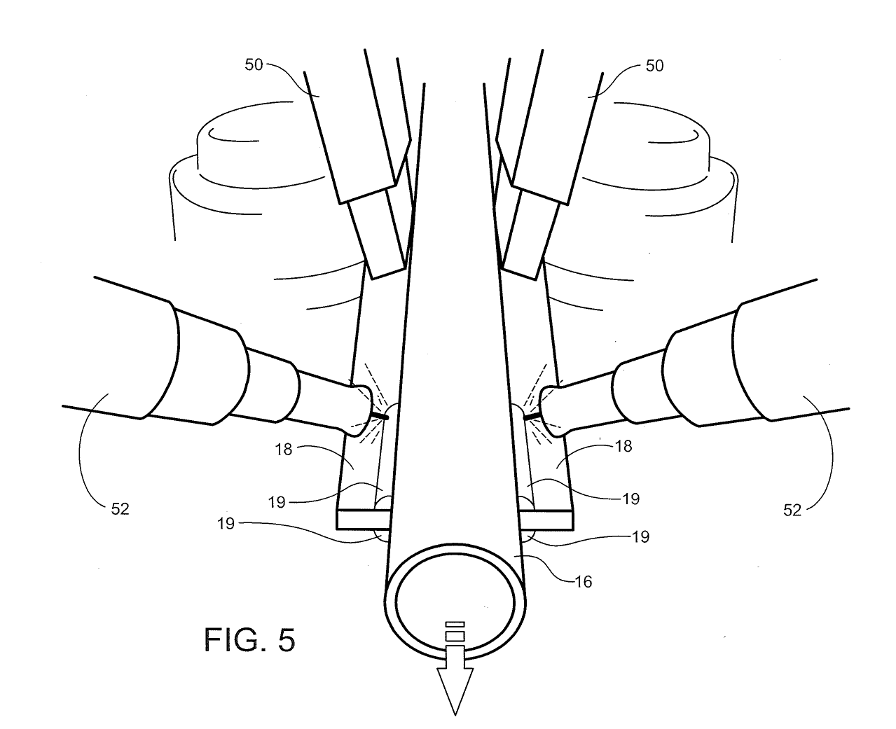

Referring now to FIG. 5, the weld beads 19 are formed by the combined effects of a focused laser beam delivered by a pair of laser weld heads 50 and a pair of GMAW weld heads 52, which utilizes a wire electrode to generate an electric arc within a blanket of an inert shielding gas. This hybrid laser arc weld (“HLAW”) system forms a molten pool of metal

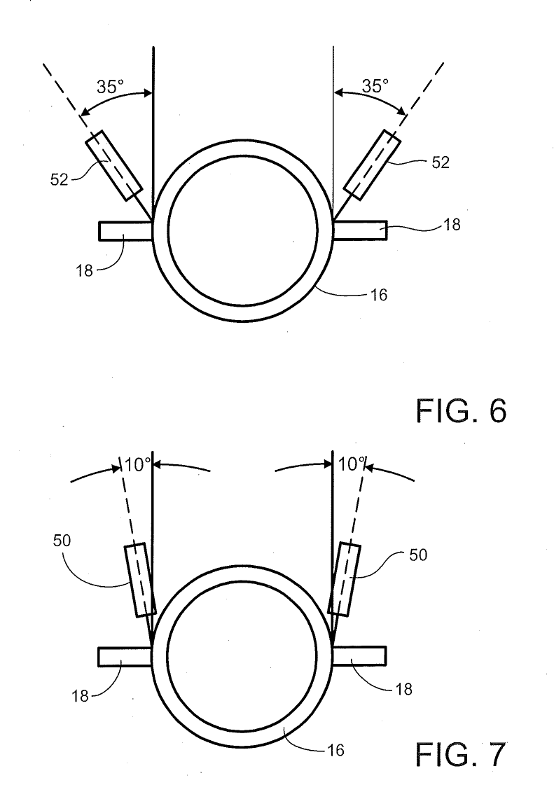

As illustrated in FIGS. 5, 6 and 7, it has been determined that the use of opposed, as distinct from staggered, laser heads 50 and GMAW weld heads 52 provide optimal results. The laser heads 50 have a work angle of 10 degrees, and the GMAW weld heads 52 have a work angle of 35 degrees.

The panel formation process takes place on a series of stations as the tubes 16 pass downstream. At a first station, an uncoiler forms the fins 18, which are narrow strips of steel that form spacers between adjacent steel tubes 16. The fins 18 are straightened, measured and cut to length. Tubes 16 are processed by cleaning, after which, according to one variation of the process,

It has been determined that the “fin-tube-fin” construction referenced above the most efficient and highest quality welds. In the process according to the preferred embodiment described in this application, the HLAW system can weld a panel with a total width of 2 meters. Depending on the size of the tube, a 1.25 inch tube 16 with a 0.5 inch fin 18 will have more than twice the number of tubes 16 in a panel of equal width than a 3-inch tube with a 1-inch fin. Panel width is largely driven by the customer based on ease of access to the work area and number of tubes that are required for the project.

The tubes and fins are tack welded together to maintain their position while being fully joined. This forms the subpanels described above, that is then placed on an infeed conveyor and moved to the infeed side of the weld area. The subpanel is gripped with drive rollers in both the vertical and horizontal planes to position the fins along a neutral axis between tubes. The subpanels are guided through the machine by three sets of profiled rollers which can be interchanged to suit the various the tube diameters and pitches. The lower transport rollers are driven by a geared motor and are adjustable in height in order to pre-stress the tubes to prevent distortion during welding.

For tube loading and setting to the tube outside diameter, the upper rollers are also adjustable in height. To assure a correct feed in case of dimension differences, they are mounted in a laminated spring element. Two pairs of lateral guide rollers are arranged in front of and behind the point where the welding spot is generated. Each roller is provided with a rotating earth connection clip to ensure unhindered welding current flow.

The subpanel, for example, subpanels 20, 30 or 40 is then introduced into the weld area. Seam trackers are activated and move first and second lasers 50 and GMAW weld heads 52 into precise welding locations on opposite slides of the tube 16 where the fins 18 join the tube 16. The seam trackers are mounted on the welding head assembly and use the principle of laser triangulation. The seam tracker includes a CCD or a CMOS-based camera, as well as its own internal laser source from a 2-D laser diode that the seam tracker uses to “paint” a laser line (stripe) along the joint to be welded. The resulting reflected scattered light is digitized by the camera sensor and image processing algorithms extract the joint profile data. Based on this joint profile data, the precise location of the “theoretical” joint and the dimensions of a gap, if there is one, between the parts to be welded are calculated and relayed to the main control system.

The lasers 50 and GMAW weld heads 52 bisect the angle of the point of contact between the fins 18 and the tube 16, with the lasers 50 being activated an instant before the GMAW weld heads 52. The lasers 50 and GMAW weld heads 52 are held in position with the seam trackers. HLAW welding takes place as the tubes and tacked fins move through the weld area.

The laser system includes an air cooled industrial chiller to maintain the laser with a temperature tolerance range. This system is sized to match the cooling requirements of the specified laser and is specified to support a 100% duty cycle. An energy dump allows the laser to operate while the optical safety shutter is closed. This system transfers the laser energy to a water-cooled heat sink. This allows the process to have quick access to full laser power on-demand. This is useful for welding activities like spot and tack welding.

The subpanels 20, 30, 40, for example, travel through the weld area from the upstream to the downstream end of the apparatus to an outfeed end, where the welded material exits the weld area onto an outfeed conveyor. A lifter lifts the welded subpanel from the outfeed conveyor and places the welded subpanel on a return conveyor that moves the welded subpanel back to the infeed conveyor. A turn-over device such as a butterfly flipper-arm system is provided for inverting the fin-tube-fin assembly to expose the unwelded side of the panel and then it is conveyed by the infeed conveyor back through the weld area where the same processes described above are repeated. The result for a panel 20 is a single tube 16 with fins 18 welded to diametrically-opposing sides with two weld beads 19 on the top and bottom on both sides of the tube 16 to hold the fins 18 in their proper position.

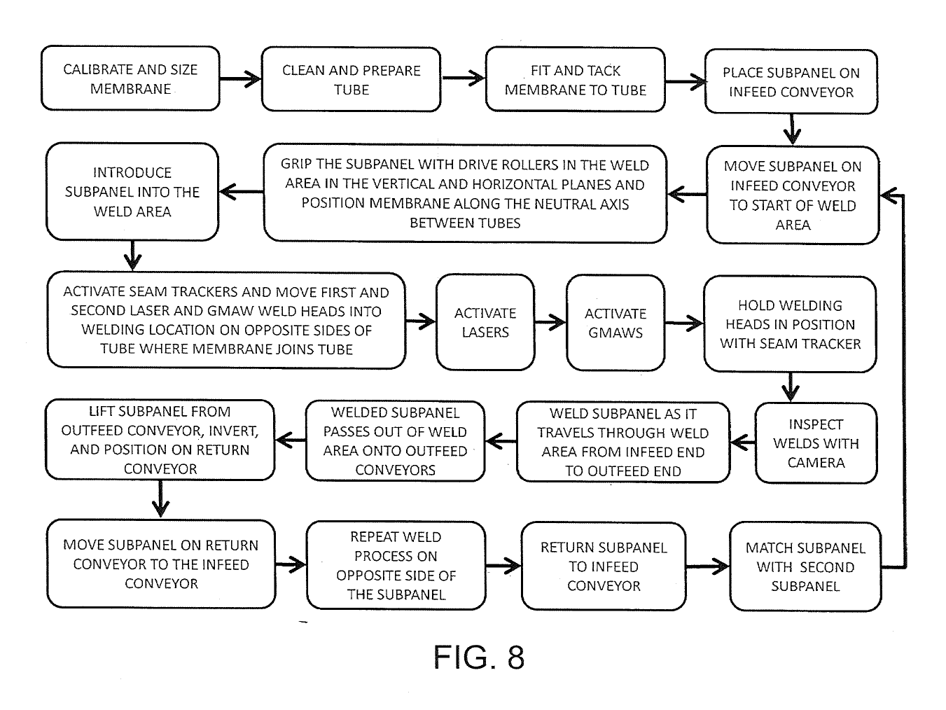

FIG. 8 illustrates the above process in flow diagram form.

The welding process described above can weld fin-tube-fin or tube-fin-tube components, as well as other required variations. These welded components can be then be welded together in the same manner to yield multiple tubes and fin sets into a tube assembly. A master process control system coordinates the operation and interaction of all of the various subsystems. This main control system also contains a parametric welding database for the specific beam and material being welded. A human machine interface (HMI) supervisory control system is provided and furnishes the operator with the ability to interact with the real-time control system as well as to observe and manage the process setup and operation.

Basic welding input and subsystem sequencing commands are available from integrated software running in a GUI. A real-time PC-based control system independently manages the welding process and all sensor inputs and control outputs and an Ethernet TCP/IP communication port allow interfacing of the GUI with a customer's network computer system.

One significant advantage gained by the addition of arc welding to the laser welding process is a relaxation of the mating surface tolerances; a joint can be created with the conventional tolerances associated with the boiler tubing and strip materials. The laser beam portion of the system can focus energy to a single spot, reducing the overheat heat input to the weld by a factor of five as compared to SAW. The lower heat input reduces the residual stresses in the weld, and reduces the amount of distortion created during welding. Also, because only a very small spot is being heated, the travel speed can be as fast as 100 to 150 inches per minute, which is on the order of three times faster than other automated welding processes like SAW.

Comparative laboratory examinations of panels fabricated by both conventional SAW and the HLAW processes have demonstrated mechanical properties equivalent to or better than SAW weld. With respect to preheat and post weld heat treatment, similar actions should be taken for panels fabricated by HLAW as would be taken for panels made by other processes.

The HLAW process surpasses the SAW process with regards to weld penetration and overall tensile strength. Furthermore, it is anticipated that the lower heat input will result in less distortion in the full size water wall panels. It is also anticipated that the higher weld deposition rates and the reduction in panel distortion favor HLAW over the SAW process for fabricating welded boiler water wall panels.

As distinct from prior art parameters, using opposed rather than staggered laser weld heads 50 and GMAW weld heads 52 and an laser work angle of 10 degrees and a arc weld head work angle of 35 degrees provides a superior product. In addition, the process step of holding the fins 18 tightly against the tubes 16 during welding eliminates variations in tracking, i.e., insuring that the fins 18 extend straight down the length of the tubes 16. Side rollers are provided to control angular deflection of the fins 18 before, during and after welding.

By way of example, an optimized weld process according to a preferred embodiment of the invention was carried out using the optimized parameters set out below, completed on 2.5″ OD SA210-A1 (0.220 mw) steel tube to ½×¼″ 1010 steel fin.

| Parameter | Optimized Parameters |
|---|---|
| Mig Mode | Synergic (Custom # 3) |
| Wire Feed Speed | 350 ipm (890 cm) |
| Average Current | 310 amps |
| Voltage (Trim) | 4.9 |
| Average Volts | 25 |
| Travel Speed | 63 ipm (91 cm) |
| Gas | 98% Ar/2% C02 |
| Gas Flow Rate | 90 cfh (2.55 cmh) |
| Process Gap | .08 in. (2 mm) |
| Laser Power | 3.5 kW front/4.2 kW back |
| Laser Focal Length | 5.4 in. (138 mm) |
| Wire Type | Coreweld 77-HS, .052″ dia |
| Gas Cup Style | Flared Nozzle |
| Contact Tip | CZ Plated |
| Wire Stickout | .67 in. (17 mm) |
| Mig Work Angle | 35° |
| Laser Angle | 10° |

Wall panels are typically fabricated of tubing having OD selected from 1.25, 2.00, 2.25, 2.5 and 3 inch OD's. Tube wall thickness ranges are typically from 0.165 through 0.400 inch, with most in the 0.200-0.300 inch range. Tube material grades are typically SA210 A1 and may have some chrome—SA213 T2, T11 or T22. The material may have an overlay, which typically is a 622 Inconel material.

The fin stock is typically 0.25 inches thick and between 0.25 and 1 inch wide. The material can be hot or cold rolled carbon steel or a grade that matches the tube being welded.

The HLAW system may travel at rates as high as 95-120 inches per minute compared to 25-45 inches per minute for the prior art SAW process.

According to a preferred embodiment of the invention, the laser weld heads 50 run at 3.5 kW front, 4.2 kW back, and the GMAW weld heads 52 run at 3.5 kW.

A method of fabricating boiler water walls utilizing hybrid laser arc welding according to the invention have been described with reference to specific embodiments and examples. Various details of the invention may be changed without departing from the scope of the invention. Furthermore, the foregoing description of the preferred embodiments of the invention and best mode for practicing the invention are provided for the purpose of illustration only and not for the purpose of limitation, the invention being defined by the claims.

What is claimed is:

1. A method of fabricating boiler water walls, comprising the steps of:
(a) forming a subpanel formed of at least one fin and one tube by laser arc welding the at least one fin to the one tube; and
(b) laser arc welding a predetermined plurality of subpanels together in a two-dimensional plane by laser arc welding an additional joining element between respective subpanels to form the water wall.

2. A method of fabricating boiler water walls according to claim 1, wherein the step of forming a subpanel formed of at least one fin and one tube comprises laser arc welding first and second fins to opposite sides of a single tube.

3. A method of fabricating boiler water walls according to claim 2, wherein the step of laser arc welding a predetermined plurality of subpanels together in a two-dimensional plane comprises the step of laser arc welding the fin of a first subpanel to a first side of a tube and laser arc welding the fin of a second subpanel to a second side of the tube opposite the first side.

4. A method of fabricating boiler water walls, comprising the steps of:
(a) forming a subpanel formed of at least one fin and one tube by laser arc welding first and second fins to opposite sides of a single tube; and
(b) forming a predetermined plurality of subpanels in a two-dimensional plane by laser arc welding the fin of a first subpanel to a first side of a tube and laser arc welding the fin of a second subpanel to a second side of the tube opposite the first side.

5. A method of fabricating boiler water walls, comprising the steps of:
(a) forming a single tube subpanel by laser arc welding first and second fins to opposite sides of a single tube;
(b) forming a predetermined plurality of three-tube subpanels in a two-dimensional plane by laser arc welding the fin of a first three-tube subpanel to a first side of a tube and laser arc welding the fin of a second three-tube subpanel to a second side of the tube opposite the first side; and
(c) forming subpanels having a progressively-larger number of tubes by laser arc welding the fins of subpanels to a first side of a tube and laser arc welding the fins of a second subpanel to a second side of the tube opposite the first side until the subpanels collectively form a water wall having a predetermined number of laser arc welded fins and tubes.

6. A method according to claim 5, wherein the step of laser arc welding comprises the steps of:
(a) providing a first laser head and a first arc weld head positioned on a first side of a subpanel comprising at least two fins and at least one tube;
(b) providing a second laser head and a second arc weld head positioned on a second side of a subpanel in opposing lateral alignment with the first laser head and arc weld head;
(c) positioning the first and second laser and weld heads to bisect an angle defining a point of contact between the fins and the tube;
(d) activating the laser heads;
(e) thereafter activating the arc weld heads; and
(f) welding the fins to the tube as the subpanel moves past the first and second laser heads and the first and second arc weld heads.

7. A method according to claim 6, wherein the fins are positioned against opposing sides of the tube and tack welded in position before the laser welding and arc welding steps occur.

8. A method of fabricating boiler water walls, comprising the steps of:
(a) determining the correct size of a plurality of fins and tubes that will form the water wall;
(b) tack welding first and second fins to opposing sides of a tube to form a subpanel;
(c) placing the subpanel on an infeed conveyor;
(d) moving the subpanel on the infeed conveyor to a laser/arc weld area;
(e) moving first and second laser heads and first and second arc weld heads into a welding location on opposite sides of the tube at the intersection of the fins and the tube;
(f) activating the first and second laser heads;
(g) activating the first and second arc weld heads;
(h) laser/arc welding the fins to the tube as the subpanel is fed through the weld area;
(i) inverting the subpanel;
(j) moving the subpanel to the infeed conveyor;
(k) repeating steps (d) through (h);
(l) matching the subpanel with a second subpanel formed according to steps (a) and (b);
(m) repeating steps (c) through (h);
(n) repeating steps (l) and (c) through (h) until a predetermined number of subpanels have been assembled and welded into a single panel.

9. A method according to claim 8, wherein the tubes have an outside diameter of 2.5 inches (6.4 cm) and the fins are 0.25 inches (0.64 cm) thick and 0.5 inches (1.27 cm) wide.

10. A method according to claim 8, wherein the work angle of the arc weld heads in relation to a point of intersection between the fin and tube is 35 degrees.

11. A method according to claim 8, wherein the work angle of the laser weld heads in relation to a point of intersection between the fin and tube is 10 degrees.

12. A method according to claim 8, wherein the work angle of the arc weld heads in relation to a point of intersection between the fin and tube is between three and four times the work angle of the laser weld heads in relation to the point of intersection between the fin and the tube.

13. A method according to claim 8, wherein the feed rate of the subpanel through the laser/arc weld area is between 60 and 120 inches (153 and 306 cm) per minute.

14. A boiler, including an at least partially-surrounding water wall comprising a plurality of parallel water tubes formed by interconnected alternating fins and tubes wherein the fins are joined to the tubes by laser arc welding.

15. A boiler according to claim 14, wherein the water wall is formed by laser arc welding a predetermined plurality of subpanels of interconnected fins and tubes together in a two-dimensional plane by laser arc welding and laser arc welding an additional fin between respective subpanels to form the water wall.

16. A boiler according to claim 14, and including a method of forming the water wall comprising the steps of:
(a) determining the correct size of a plurality of fins and tubes that will form the water wall;
(b) tack welding first and second fins to opposing sides of a tube to form a subpanel;
(c) placing the subpanel on an infeed conveyor;
(d) moving the subpanel on the infeed conveyor to a laser/arc weld area;
(e) moving first and second laser heads and first and second arc weld heads into a welding location on opposite sides of the tube at the intersection of the fins and the tube;
(f) activating the first and second laser heads;
(g) activating the first and second arc weld heads;
(h) laser/arc welding the fins to the tube as the subpanel is fed through the weld area;
(i) inverting the subpanel;
(j) moving the subpanel to the infeed conveyor;
(k) repeating steps (d) through (h);
(l) matching the subpanel with a second subpanel formed according to steps (a) and (b);
(m) repeating steps (c) through (h);
(n) repeating steps (l) and (c) through (h) until a predetermined number of subpanels have been assembled and welded into a single panel.
